(19) United States
(12) Patent Application Publication
(10) Pub. No.: US 2014/0108043 A1
(43) Pub. Date: Apr. 17, 2014

(54) CONFIGURABLE HEALTH HISTORY FORM BUILDER

(71) Applicant: ATHENAHEALTH, INC., Watertown, MA (US)

(72) Inventors: Chip W. Ach, Sudbury, MA (US); Matthew Hendrix, Somerville, MA (US); Cal Pierog, Cambridge, MA (US); Kathryn A. Rodden, Waltham, MA (US); Libby C. Webb, Somerville, MA (US)

(73) Assignee: athenahealth, Inc., Watertown, MA (US)

(21) Appl. No.: 13/650,871

(22) Filed: Oct. 12, 2012

(51) Int. Cl. G06Q 50/24

(52) U.S. Cl. 705/3

(57) ABSTRACT

Methods and apparatus for providing customized health history forms for use with a practice management system. The practice management system provides a user interface that enables a user at a medical practice to configure a health history form template. The user at the medical practice provides configuration input via the user interface to produce a configured health history form template, which is stored by the practice management system. A customized health history form may be generated based on the configured health history form template in response to a patient scheduling an appointment of a particular appointment type at the medical practice. The customized health history form may be provided to the patient.

### BACKGROUND

When a patient arrives at a medical practice for an appointment, the patient is often asked to fill out a form that includes a series of questions related to, among other things, biographical information and health history information. After completing the questionnaire, the patient may give the completed form to administrative staff at the medical practice who places the form with the patient's medical record. A medical practitioner, such as a nurse or physician, may review the information on the form with the patient during examination of the patient to ensure the medical record accurately reflects the patient's current condition and health history.

With the advent of electronic medical records (EMRs—also known as electronic health records (EHRs)), health history information for a patient may be stored electronically rather than being stored using paper files. Accordingly, for medical practices that use an EHR system, rather than attaching the completed health history form to a patient's physical medical record, administrative staff at the medical practice may enter the patient's responses on the form into a computer system that stores the patient's health record. Subsequently, when a medical professional examines the patient, the information may be retrieved on a computer terminal in the examination room connected to the EHR system, rather than referencing the information using paper files. Alternatively, paper files may be used while the patient is at the medical practice and the patient's electronic health record may be updated at a later time.

Some medical practices contract with third-party providers of a practice management system to manage electronic health information for patients of the medical practice. For example, information related to patient visits, lab results, current medications, among other things, may be stored by the practice management system and this information may be made available to physicians or other staff at a medical practice though a network-based system in order to facilitate patient care.

### SUMMARY

The inventors have recognized and appreciated that medical practices that contract with third-party providers of a practice management system do not have the ability to configure their own unique health history forms for use with the practice management system. Additionally, medical practices often decide not to use standard health history forms provided by a practice management system because these standard forms typically do not meet the needs of the robust and varied information a medical practice would like to collect from patients. Instead, medical practices often provide patients with printable paper-based forms that include questions designed to elicit the desired information, but these questions do not map directly to patient-specific medical information in the patient's electronic health record stored by the practice management system.

Because there is no direct mapping between questions on the paper-based form and information in the patient's electronic health record, a user at the medical practice is often required to perform a manual conversion process to enter the patient's responses into the patient's electronic health record. To this end, some embodiments of the invention are directed to methods and apparatus for enabling a user at a medical practice to create and configure health history form templates that include appropriate and informative questions for the medical practice, and also allow for a mapping between the questions on the health history form and information in patients' electronic health records stored by the practice management system.

Some embodiments are directed to a method of providing a health history form for use with a practice management system, the method comprising: determining that a patient of a medical practice associated with the practice management system has scheduled an appointment, wherein the appointment has an appointment type; generating the health history form using a health history form template stored by the practice management system, wherein the generating is based, at least in part, on the appointment type; populating the health history form with patient data stored by the practice management system to create a pre-populated health history form; and providing the pre-populated health history form to the patient for completion prior to the appointment.

Some embodiments are directed to a computer system including at least one server computer configured to host a practice management system. The at least one computer comprises at least one storage device configured to store a plurality of health history form templates, wherein each of the plurality of health history form templates is associated with at least one appointment type; and at least one processor programmed to provide a user interface that enables a user at a medical practice associated with the practice management system to configure at least one of the plurality of health history form templates.

Some embodiments are directed to at least one computer-readable medium encoded with a plurality of instructions that, when executed by at least one computer configured to host a practice management system, perform a method, comprising: providing a user interface that enables a user at a medical practice associated with the practice management system to configure a health history form template stored by at least one storage device associated with the practice management system; receiving configuration input via the user interface to configure the health history form template to produce a configured health history form template; and storing the configured health history form template on the at least one storage device.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic of a practice management system for use with some embodiments of the invention;

FIG. 2 is a portion of a user interface displaying a health history form generated in accordance with some embodiments of the invention;

FIG. 3 is a flow chart of a process for configuring a health history form template in accordance with some embodiments of the invention;

FIG. 4 is a portion of a user interface for configuring a health history form template in accordance with some embodiments of the invention;

FIG. 5 is a portion of a user interface for configuring general information for a health history form template in accordance with some embodiments of the invention;

FIG. 6 is a portion of a user interface for selecting a section of a health history form template to configure in accordance with some embodiments of the invention;

FIG. 7 is a portion of a user interface for configuring a section of a health history form template in accordance with some embodiments of the invention;

FIG. 8 is a portion of a user interface for configuring questions to include in a health history form template in accordance with some embodiments of the invention;

FIG. 9 is a portion of a user interface for previewing a health history form generated from a health history form template in accordance with some embodiments of the invention;

FIG. 10 is a portion of a user interface for selecting a patient used in creating a preview of a health history form generated from a health history form template in accordance with some embodiments of the invention;

FIG. 11 is a portion of a user interface for posting a health history form template to a web-based portal in accordance with some embodiments of the invention;

FIG. 12 is a flow chart of a process for generating a health history form based on a health history form template stored by a practice management system in accordance with some embodiments of the invention;

FIG. 13 is a flow chart of a process for receiving information from a patient using a health history form generated in accordance with some embodiments of the invention;

FIG. 14 is a flow chart of a process for reconciling form data with patient data stored by a practice management system in accordance with some embodiments of the invention;

FIG. 15 is a portion of a user interface for selecting a form having data to reconcile in accordance with some embodiments of the invention;

FIG. 16 is a portion of a user interface for selecting items to reconcile in accordance with some embodiments of the invention;

FIG. 17 is a portion of a user interface displaying a portion of a completed health history form generated in accordance with some embodiments of the invention;

FIG. 18 is a portion of a user interface displaying sections of a health history form that include data to be reconciled in accordance with some embodiments of the invention;

FIG. 19 is a portion of a user interface for performing data reconciliation in accordance with some embodiments of the invention;

FIG. 20 is a portion of a user interface displaying a summary of data reconciled in accordance with some embodiments of the invention; and

FIG. 21 is a schematic of an illustrative computer system on which some embodiments of the invention may be employed.

### DETAILED DESCRIPTION

The present disclosure generally relates to inventive methods and apparatus for facilitating the collection of patient health history information in a practice management system, and more specifically relates to generating customized health history forms using information stored by the practice management system. By generating customized health history forms, a medical practice, department, and/or specialty may design forms tailored to their particular needs.

Some practice management systems may include a standard health history form that includes common questions an administrator and/or programmer of the practice management system believes will be applicable to a majority of medical practitioners and patients. The inventors have recognized, however, that medical practitioners do not frequently use such standard health history forms because they often do not elicit the type of information the practitioners are seeking from their patients. For example, the standard forms may include too many questions that are irrelevant to a particular department, specialty, or patient, resulting in the patient having to guess whether they should fill out particular questions or not. This often results in the patient filling out too little information or spending unnecessary time filling out information that the medical practitioner is not interested in. Additionally, a medical practitioner may want questions phrased in a particular manner which is not captured by the questions on the standardized health history form.

For these reasons and others, even if a practice management system provides a standard health history form to allow patients to enter health history information prior to arriving at the medical practice for an appointment, many medical practices may not use the standard health history form in favor of paper forms created by an administrator at the medical practice. However, the paper-based forms created by a user at the medical practice do not map directly to types of patient data stored by the practice management system, resulting in time-consuming manual data entry for medical practitioners.

To this end, some embodiments of the invention are directed to methods and apparatus for automatically generating a web-based health history form that includes such data mappings and is tailored to the needs of a medical practice, department, and/or specialty. As described in more detail below, questions presented on the web-based form may be filtered for relevance to a particular department at a medical practice and/or characteristics of particular patients (e.g., male/female) to focus the questions on the form to information that the medical practice desires to collect from particular patients and to eliminate unnecessary questions. Additionally, in some embodiments, at least some of the fields on the form may be automatically completed based on a patient's electronic health information stored by the practice management system, as discussed in more detail below.

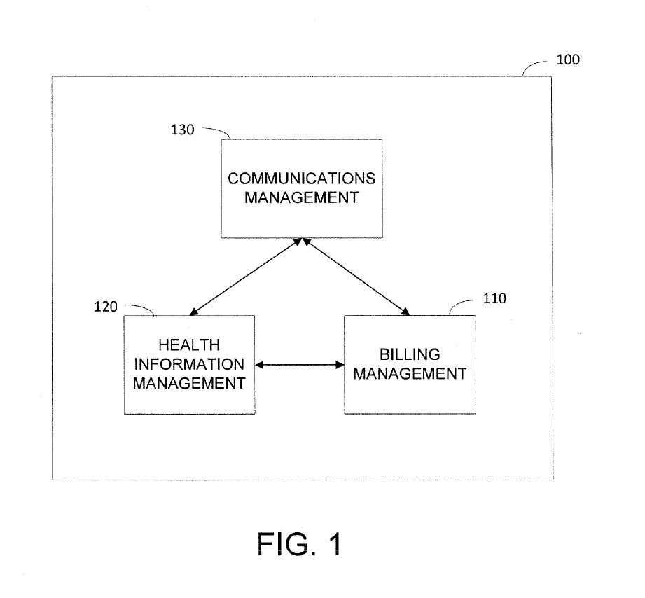

A block diagram of a practice management system in accordance with some embodiments of the invention is shown in FIG. 1. Practice management system 100 may be a networked system that includes a plurality of components configured to perform tasks related to specific functions within the practice management system to facilitate the management of various aspects of medical practices including, billing, managing health information, and communications with patients.

Exemplary practice management system 100 includes health information management component 120, which is configured to store electronic health information for patients at medical practices including, but not limited to electronic medical records, lab results, imaging results, and pay for performance requirements related to patients of the medical practice. Practice management system 100 also includes billing management component 110, which is configured to facilitate the collection and tracking of claims filed by the medical practice to a plurality of payers (including patients) to ensure that the medical practice is properly compensated for medical services rendered to patients treated at the medical practice.

Exemplary practice management system 100 also includes communications management component 130, which interacts with health information management component 120 and billing management component 110 to automate interactions with patients on behalf of the medical practice. As discussed in more detail below, communications management component 130 may include a web-based portal implemented as a portion of a web application, with which patients may interact to perform a plurality of actions associated with services at a medical practice including, but not limited to, registering to be a new patient at a medical practice, providing a third party with access to interact with the medical practice, secure messaging of protected health information (PHI) with authorized medical personnel, submitting electronic payment information for medical bills, accessing educational content, completing medical forms, and receiving directions to the medical practice. An exemplary implementation of web-based portal in accordance with some embodiments of the invention is described in more detail below.

Although practice management system 100 is only shown as having three components, it should be appreciated that practice management system 100 may include any number of components (including less than three components) that interact in any suitable way and embodiments of the invention are not limited in this respect. Furthermore, some or all of the components in practice management system 100 may interact by sharing data, triggering actions to be performed by other components, prevent actions from being performed by other components, storing data on behalf of other components, and/or interacting in any other suitable way.

The inventors have recognized and appreciated that a substantial bottleneck in efficiently managing a patient workflow during a patient visit to a medical practice involves patients completing health history forms after a patient arrives at the medical practice. Accordingly, some embodiments are directed to improving the efficiency of a patient visit to a medical practice by prompting and enabling patients to complete health history forms via a web-based portal in advance of their scheduled appointment.

As discussed above, the inventors have also recognized that some standard health history forms provided by practice management systems include questions that are not relevant to particular patients, departments, and/or appointment types. To this end, some embodiments are directed to generating a customizable health history form for patients of a medical practice that includes a set of questions that focuses on individual appointment and/or patient characteristics. In some embodiments, the data entered into the health history forms are automatically reconciled with data stored by the health information management component of the practice management system using mappings between at least one data field in the health history form and a type of patient data stored by the practice management system. In one implementation, discrepancies which cannot be automatically resolved are noted for manual follow-up procedures, as discussed in more detail below.

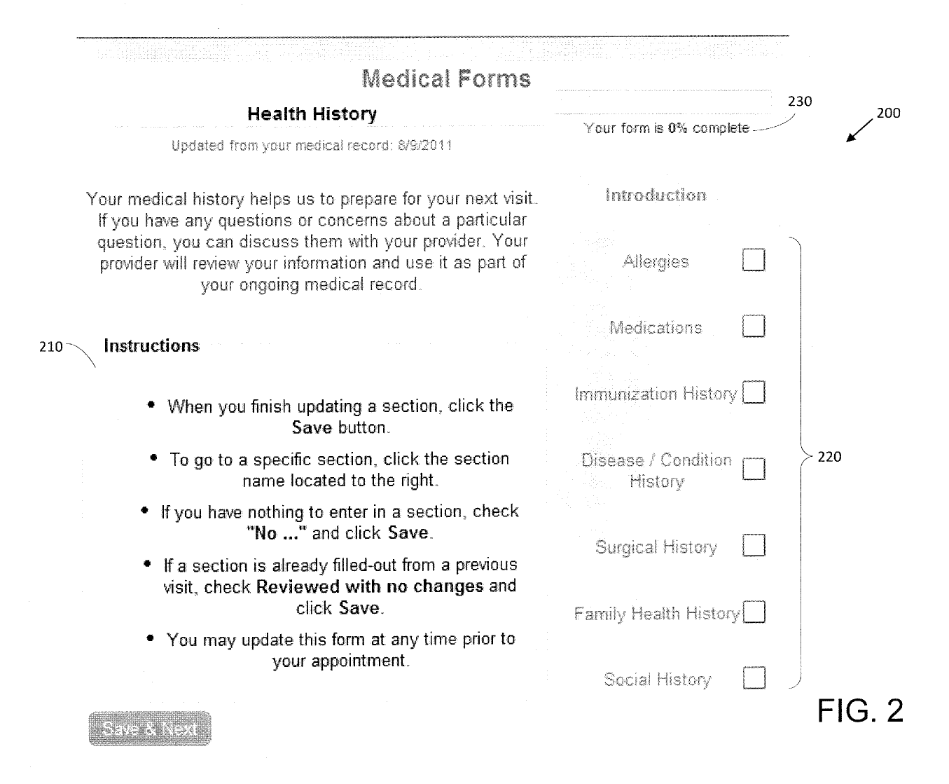

An exemplary health history form 200 that may be generated for use within a web-based portal provided by a practice management system in accordance with some embodiments of the invention is illustrated in FIG. 2. A patient may complete information in the health history form by entering information in fields presented on one or more web pages corresponding to different sections of the health history form. As shown in FIG. 2, the health history form may include instructional information 210 that informs the patient how to complete the health history form. Health history form 200 may also include one or more section selectors 220 that, when selected, cause the web-based portal to navigate to a web page associated with the selected section. In some embodiments, a selection of a section selector 220 may also indicate that the section has been completed. As discussed in further detail below, each section of the health history form may include one or more questions to prompt a patient to enter health history information into the form.

In some embodiments, the health history form may also include a completion indicator 230 that identifies how much information in the health history form has been completed. As discussed briefly above, some practice management systems may include reconciliation functionality that enables information in a health history form to be reconciled with information stored in the patient's medical record by the practice management system. In some embodiments, such reconciliation may occur only after a particular amount of information has been completed (e.g., 50%), though in other embodiments, information entered into a health history form may be reconciled with existing health information stored by the practice management system at any time, including immediately upon entry.

In some embodiments, a user (e.g., an administrator) at a medical practice may create a new health history form template or modify an existing health history form template by interacting with a health history form builder tool provided by a practice management system. The health history form builder tool may present a plurality of interactive web pages rendered by a web browser on the user's computer and the user may create and/or configure portions of a health history form template by interacting with one or more fields presented on the plurality of interactive web pages. In some embodiments, the health history form builder tool may be implemented by a communications management component of the practice management system, which is configured to present the interactive web pages to authorized users of the medical practice.

A practice management system used in accordance with some embodiments may store a plurality of health history form templates for a plurality of medical practices associated with the practice management system. The plurality of health history form templates may be configured by users of individual medical practices to generate health history forms to be presented to patients of their medical practices. A user (e.g., an administrator) at a medical practice may configure an existing health history form template stored by the practice management system or generate a new health history form template by interacting with the health history form builder tool provided by the practice management system. Once configured, health history forms corresponding to the health history form templates may be generated and made accessible to patients of the medical practice to collect patients' health history information prior to the patients' arrival at the medical practice for a scheduled appointment. For example, in some embodiments, the health history form(s) may be posted on a web-based portal on which patients are authorized to complete the forms, as discussed above.

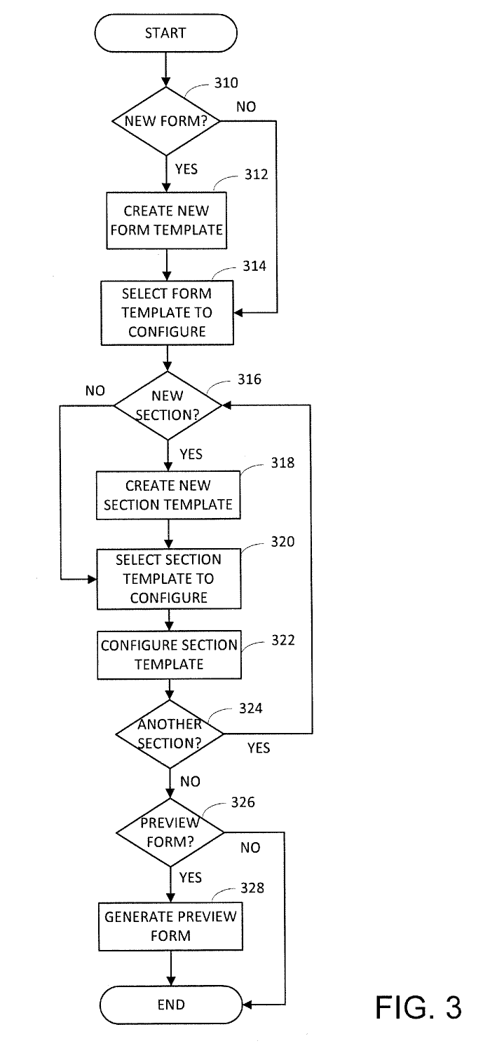

FIG. 3 illustrates an exemplary process for configuring a health history form template for use in a practice management system in accordance with some embodiments of the invention. In act 310, it is determined whether the user wants to add a new health history form template or modify an existing health history form template. If it is determined in act 310 that the user wants to create a new form template, the process proceeds to act 312, where a new health history form template is created by the health history from builder tool. After creation of the new health history form template in act 312, or if it is determined in act 310 that the user wants to modify an existing health history form template, the process proceeds to act 314, where a user selects a health history form template to configure. Upon receiving a selection of a health history form template to configure, the process proceeds to act 316 where it is determined whether the user wants to add a new section to the selected health history form template. If it is determined in act 316 that the user wants to add a new section to the health history form template, the process proceeds to act 318 where a new section for the health history form template is created.

After creation of a new section in act 318, or if it is determined in act 316 that the user wants to configure an existing section of the health history form template, the process proceeds to act 320, where a selection of a section to configure is received. In response to receiving a selection of a section to configure, the process proceeds to act 322, where the selected section is configured. A section of a health history form template may be configured in any suitable way including, but not limited to, adding, removing, and rearranging the order of questions in the section. In some embodiments, certain sections of a health history form template (e.g., medications, allergies) may not require configuration by a user, whereas other sections of the health history form template may be configured, as described herein, and embodiments of the invention are not limited by the extent of configuration required for each section of the health history form template.

After the section has been configured, the process proceeds to act 324, where it is determined whether the user wants to configure another section of the health history form template. If it is determined in act 324 that the user wants to configure another section of the health history form template, the process returns to act 316 where it is determined whether the next section to configure is a new section or an existing section. If it is determined in act 324 that the user does not want to configure another section of the health history form template, the process proceeds to act 326 where it is determined whether the user wants to preview a health history form that will be generated based on the configured health history form template. If it is determined in act 326 that the user wants to generate a preview, the process proceeds to act 328 where the health history form builder tool generates a health history form using in the configured health history form template. If it is determined in act 326 that the user does not want to generate a preview form, the process ends.

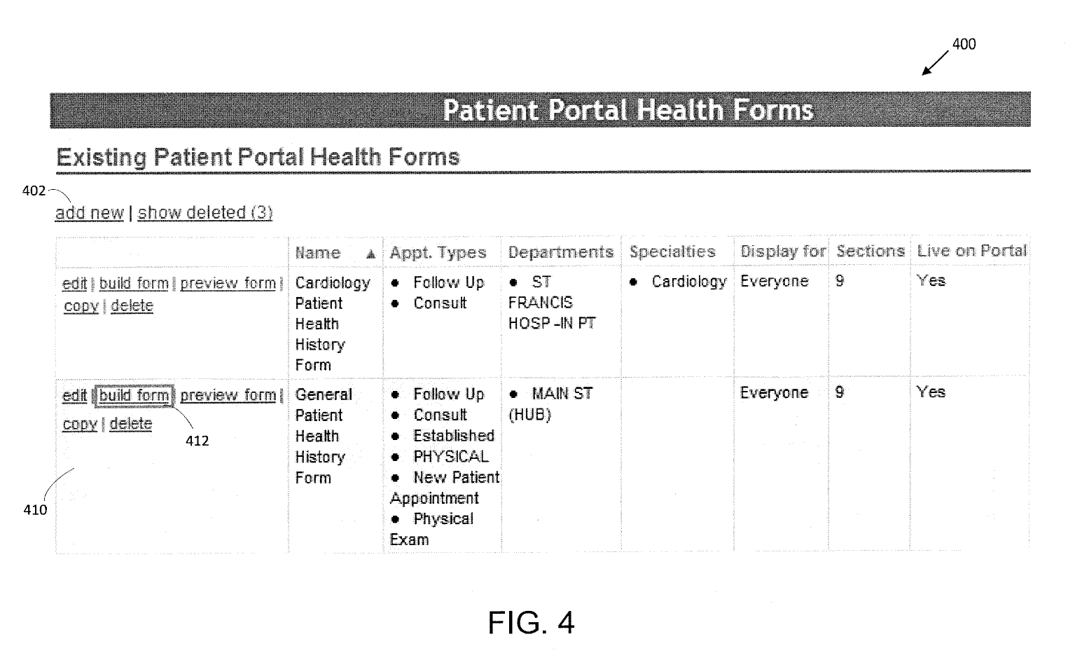

An exemplary implementation for configuring a health history form template using a health history form builder tool in accordance with some embodiments of the invention is discussed below with reference to FIGS. 4-11. Configuration input received via a user interface corresponding to the health history form builder tool is used to produce a configured health history form template that is specific to the needs of a particular medical practice, department, and/or specialty, and is linked to one or more appointment types.

As shown in FIG. 4, upon accessing the health history form builder tool, an authorized user of a medical practice may be presented with a health forms page 400 that enables the user to add a new health history form template and/or configure an existing health history form template, as discussed above. In some embodiments, the health forms page 400 may display only a subset of all of the patient health history form templates stored by the practice management system. For example, if a user is associated with a particular medical practice, only health history form templates for that medical practice may be displayed on the user interface. In other embodiments, all health history form templates stored by the practice management system may be displayed on the user interface and embodiments are not limited in this respect.

Health forms page 400 may include add selector 402 with which the user may interact to create a new health history form template. Health forms page 400 may also provide an indication of existing health history form templates stored by the practice management system for the medical practice. Each of the existing health history form templates may be associated with a selector section 410 that includes a plurality of selectors for configuring the corresponding health history form template, as discussed in more detail below. For example, selector section 410 may include a build selector 412 that, when selected, causes the health history form builder tool to navigate to a web page that enables a user to configure one or more sections of the health history form template.

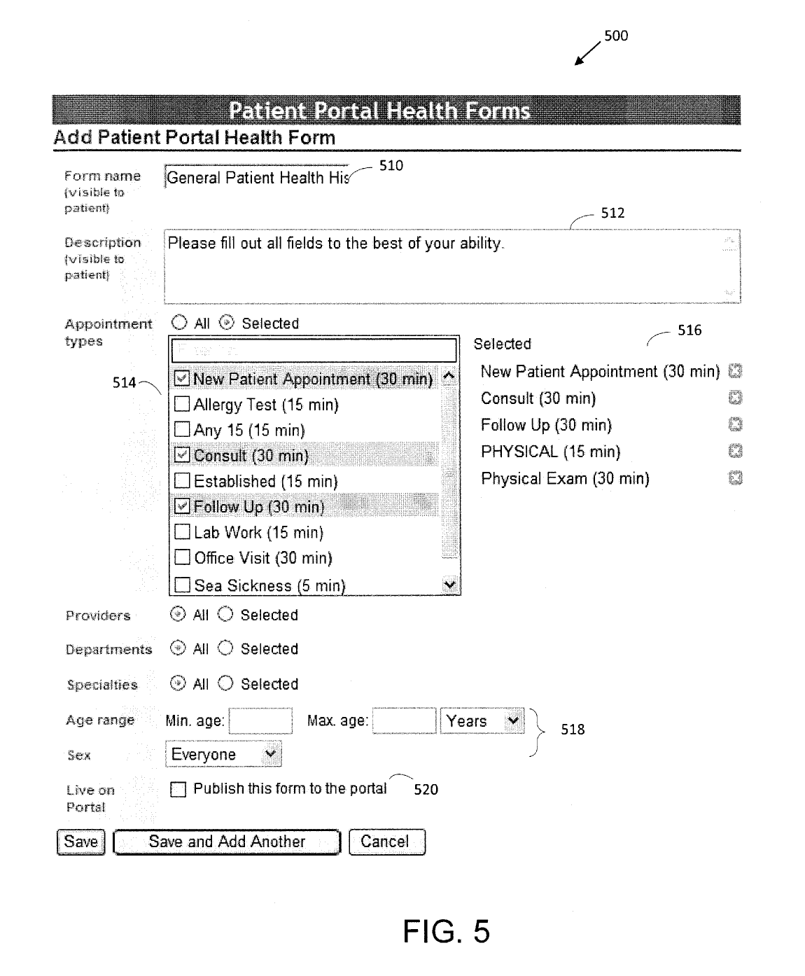

Health forms page 400 may also display general information about each of the existing health history form templates accessible to the user for configuration. For example, in some embodiments, health history form templates may be linked to one or more appointment types, departments, and/or specialties for a medical practice and this information may be shown on health forms page 400, as illustrated in FIG. 4. By linking health history form templates with particular appointment types, each time a patient schedules an appointment of a particular type, the patient may be prompted to access a web-based portal to complete health history form(s) generated from the templates associated with the particular type. For example, prior to the patient's appointment, the practice management system may send an automated message (e.g., email, text message, phone call) to the patient to remind the patient of the appointment and to instruct the patient to complete one or more forms using the web-based portal. Configuring general information associated with health history form templates is discussed in more detail below in connection with FIG. 5.

FIG. 5 illustrates a form creation page 500 with which a user may interact to create a new health history form template. Form creation page 500 may enable a user to configure general information for the new health history form template. For example, form creation page 500 may include descriptive fields, including name field 510 and description field 512, that include information about the health history form which will be presented to a patient who will be completing the form once configured.

As discussed above, in some embodiments, health history form templates may be linked with one or more appointment types. By linking a health history form template with an appointment type, a corresponding health history form may be generated in response to scheduling an appointment for a patient at a medical practice. Accordingly, form creation page 500 may also include appointment types section 514 that allows a user to select one or more appointment types to link to the health history form template. The linked appointment type information received as configuration input may be associated with the health history form template in any suitable way.

Form creation page 500 may additionally display an appointment summary section 516 that provides the user with an alternate view of which appointment types have been selected for linking with the health history form template. The user may interact with appointment summary section 516 to delete appointment types that had previously been selected for association with the health history form template. It should be appreciated that any suitable manner of enabling a user to link appointment types to health history form templates may be used and form creation page 500 shown in FIG. 5 is provided merely as one example.

In some embodiments, the health history form template being created may also be linked with one or more providers, departments, and/or specialties at a medical practice. Any combination of provider, department, and specialties may be configured by the user and embodiments of the invention are not limited in this respect. For example, a user may choose to use the same form for all providers, departments, and specialties, a user may choose to create a separate form for each combination of provider, department, and specialty, or a user may use the same form for some providers, departments, and specialties, but not others.

The inventors have recognized that some questions on a health history form are only applicable to patients having particular characteristics. Accordingly, form creation page 500 also includes one or more patient-specific fields 518 used to associate the health history form template with one or more patient characteristics. For example, the health history form template may be associated with an age range field, so only patients within the specified age range are prompted to complete the form prior to an appointment. Additionally, some forms may be associated with a particular gender of patient or the form may be linked to patients of both genders. Patient-specific fields other than age and gender may also be used for linking health history form templates with patient characteristics and embodiments of the invention are not limited in this respect. For example, a medical practice may want to configure a form to include additional questions for certain patients previously diagnosed with a particular disease. The user may choose to associate an entire form with patients having the particular disease or particular sections of the form may be tailored to ask for additional information from these patients. Configuration of sections of a health history template and configuration of questions within sections is discussed in more detail below.

Form creation page 500 may also include publish selector 520 that, when selected by a user enables the use of a health history form created in accordance with the health history form template to be accessed by a patient via a web-based patient portal after the patient has scheduled an appointment. After the new health history form template has been created, the health history form template may be added to an existing repository of health history form templates stored on one or more datastores associated with the practice management system. Although FIG. 5 has been discussed with reference to adding a new health history form template to a repository of health history form templates stored by a practice management system, existing health history form templates may also be edited using a user interface similar to that shown in FIG. 5. Upon reconfiguration of the general information for an existing health history form template, the updated general information may be stored by the practice management system in any suitable way to reflect the updated status of the health history form template.

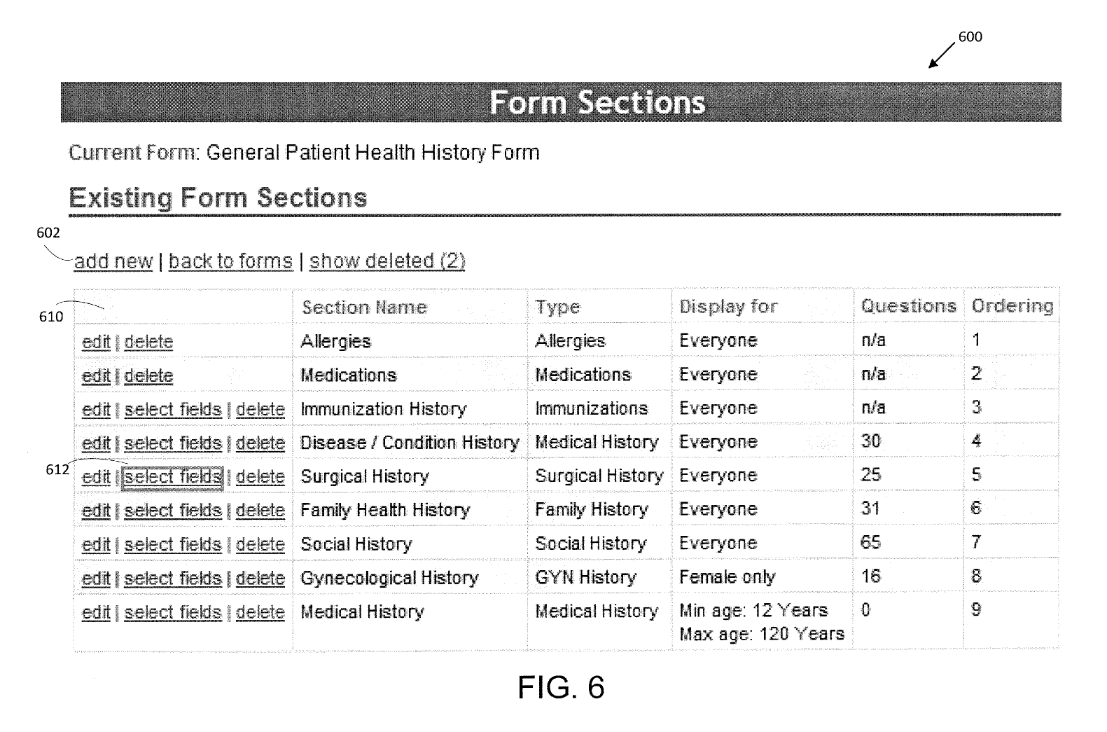

In some embodiments, health history form templates are divided into a plurality of sections and one or more of the plurality of sections are configurable by a user at a medical practice. After a user has selected a health history form template to configure (e.g., by interacting with build form selector 412 of health forms page 400), the health history form builder tool may navigate to form section page 600, where a user can create and/or configure one or more sections of the selected health history form template, as shown in FIG. 6.

As shown in FIG. 6, form section page 600 may include a plurality of user-selectable links that, when selected by a user enables the user to add a new section to a health history form template and/or configure an existing section of the health history form template. In some embodiments, the form section page 600 may display only a subset of all of sections of a health history form template that may be configured by a user. For example, the practice management system may be configured to provide only certain authorized users the ability to configure one or more sections of a health history form and only those sections a user is authorized to configure may be displayed. In other embodiments, all sections of a health history form may be displayed on form section page 600.

Form section page 600 may include add selector 602 with which the user may interact to create a new section for the health history form. Form section page 600 may also display previously-created sections of the health history form stored by the practice management system. Each of the sections of the health history form may be associated with a selector section 610 that includes a plurality of selectors for configuring a corresponding section of the health history form, as discussed in more detail below. For example, selector section 610 may include a fields selector 612 that, when selected, causes the health history form builder tool to navigate to a web page that enables a user to configure one or more questions in the corresponding section of the health history form.

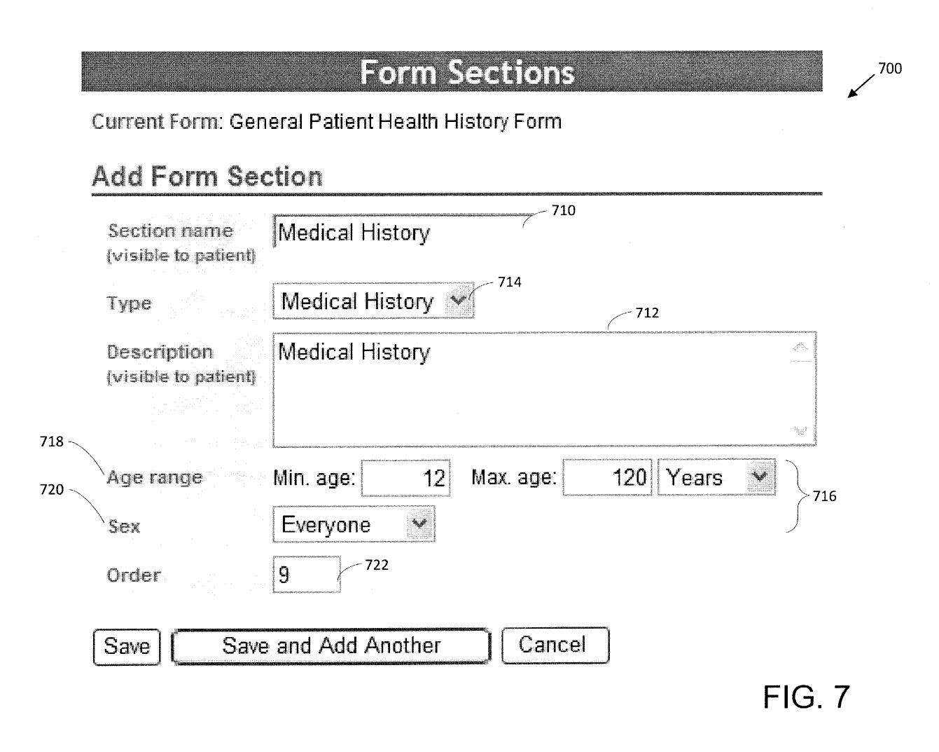

Form section page 600 may also display information for each of the sections of the health history form template. For example, in some embodiments, sections of a health history form template may be associated with a section name and/or a section type and this information may be shown on form section page 600, as illustrated in FIG. 6. In some embodiments, form sections may be configured to be displayed for all patients or some form sections may be configured to be displayed for a subset (e.g., only female) of patients, and this information may be reflected on form sections page 600. By associating different form sections with particular patient populations, health history forms may be customized for individual patients of a medical practice by displaying relevant sections for the patient to complete and not displaying irrelevant sections. Other information including, but not limited to, the number of questions in the section and an order to display the sections on the health history form may also be shown on form sections page 600, as illustrated in FIG. 6. Configuring information for a particular section of a health history form is discussed in more detail below in connection with FIG. 7

FIG. 7 illustrates a section creation page 700 with which a user may interact to create a new section for a health history form template. Section creation page 700 enables a user at a medical practice to configure information for the new section of the health history form template by interacting with fields on section creation page 700 including, but not limited to, descriptive fields such as name field 710 and description field 712, which display information about the health history form to a patient who will be completing the form once generated. In some embodiments, a section may be associated with a particular type (e.g., “Medical History,” “Medications”) and section creation page 700 may include a type selector 714 with which a user may interact to change the type of the section. Although FIG. 7 illustrates type selector 714 as being a pull-down menu with a fixed number of choices, it should be appreciated that type selector 714 may be implemented in any suitable way including an implementation that enables the user to create a new type to associate with the section.

As discussed above, some sections of a health history form template may be configured so that the section(s) are displayed to certain patients and not others. Accordingly, section creation page 700 may include patient population selectors 716 that enable a user to configure whether the section should be displayed depending on one or more patient characteristics. For example, section creation page 700 may include age range selector 718 and gender selector 720 that a user may interact with to inform the practice management system which patient populations should be associated with the section being configured. Patient-population characteristics other than age and gender may also be used for associating a section of a health history form template with patient characteristics and embodiments are not limited in this respect. For example, a medical practice may want to configure a section of health history form to include additional questions for certain patients previously diagnosed with a particular disease. The user may choose to associate an entire section of a health history form with patients having the particular disease or particular questions of the form may be tailored to ask for additional information from these patients. Configuration of questions within sections is discussed in more detail below.

Section creation page 700 may also include order selector 722 that enables a user to change the order that the section will be displayed on the health history form generated from the template. By enabling medical practices the flexibility to change the order of sections in a health history form, each medical practice may, for example, configure electronic forms to closely resemble paper forms the practice conventionally used prior to adoption of electronic health history forms in accordance with embodiments of the invention. Although FIG. 7 has been discussed with reference to adding a new section to health history form template stored by a practice management system, existing sections of the health history form template may also be edited using a user interface similar to that shown in FIG. 7. Upon reconfiguration of the information for a section of the health history form template, the updated information may be stored by the practice management system in any suitable way to reflect the updated status of the section of the health history form template.

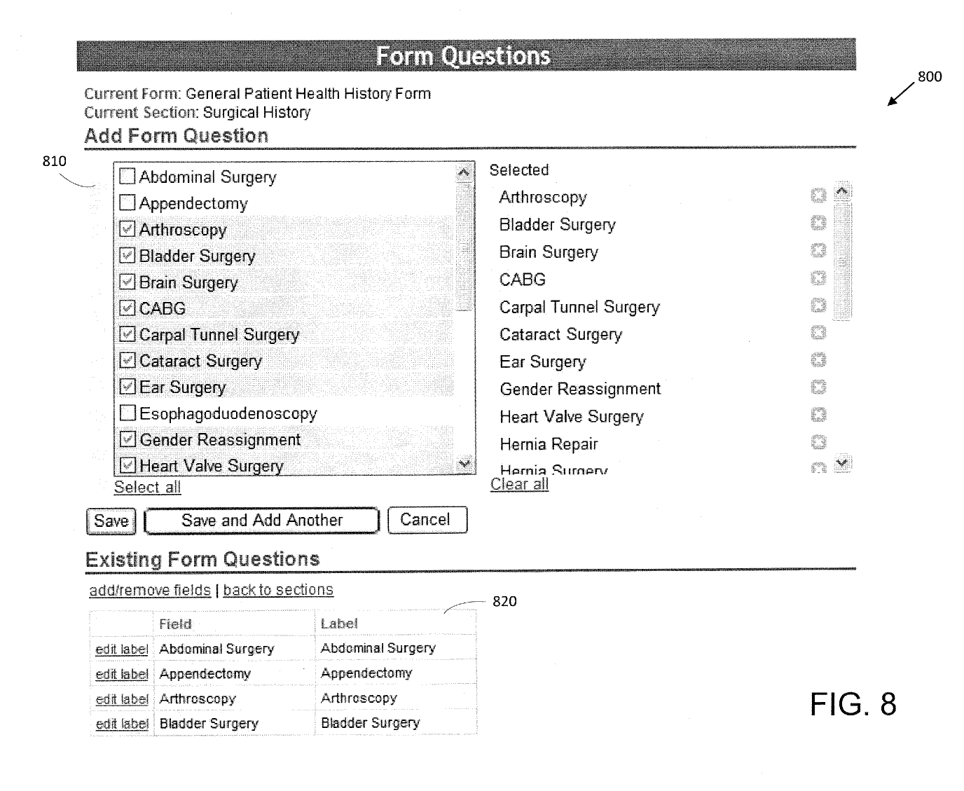

In some embodiments, sections of a health history form template may be further configured by specifying which questions should appear in each section. In response to determining that a user wants to configure the questions in a particular section (e.g., by determining that a user has interacted with fields selector 612), the health history form builder tool may navigate to form question page 800, as shown in FIG. 8. Form question page 800 may include a plurality of fields with which a user may interact to add one or more questions to the section that is being configured. For example, form question page 800 may display the existing fowl questions for the section (i.e., questions that have already been associated with the section) and a user may interact with form question page 800 to add or remove questions from the section by selecting or deselecting questions (or question types) displayed in an add form question portion 810 of form question page 800.

In some embodiments, the questions displayed in add form question portion 810 are determined by a programmer or administrator of a practice management system. However, in other embodiments, a user at a medical practice may add or customize questions to include in the section without the questions having been previously determined by a programmer or administrator of the practice management system. By providing a user at the medical practice flexibility regarding the content and form of the questions included in each section, the user may be able to create an electronic form having questions identical or similar to those on paper forms used by the medical practice prior to their adoption of electronic health history forms. Accordingly, in some embodiments, the adoption of electronic health history forms by a medical practice may be more or less transparent to patients of a medical practice who are accustomed to answering a particular set of questions prior to visiting the medical practice as the questions on the electronic health history form(s) may remain the same.

In some embodiments, form question page 800 may be configured to enable a user to associate a label 820 with one or more questions selected for a particular section of a health history form template. The label 820 may be displayed to a patient on a user interface (e.g., using a web-based portal) to identify the question when the health history form is presented to a patient for completion prior to their appointment at the medical practice. Additionally, in some embodiments, form question page 800 may be configured to enable a user at a medical practice to change the order of questions within a section of the health history form template. Other modifications to form question page 800 to enable users at a medical practice to have more or less control over the configurability of questions within a section of a health history form template are also possible, and embodiments are not limited by the extent to which the user is able to configure the questions in a section of the health history form template.

After the user has selected and/or deselected the questions for a particular section, the user may continue to select and/or deselect questions for other sections until the user is satisfied that the health history form template has been configured in accordance with the needs of the medical practice, department, and/or specialty.

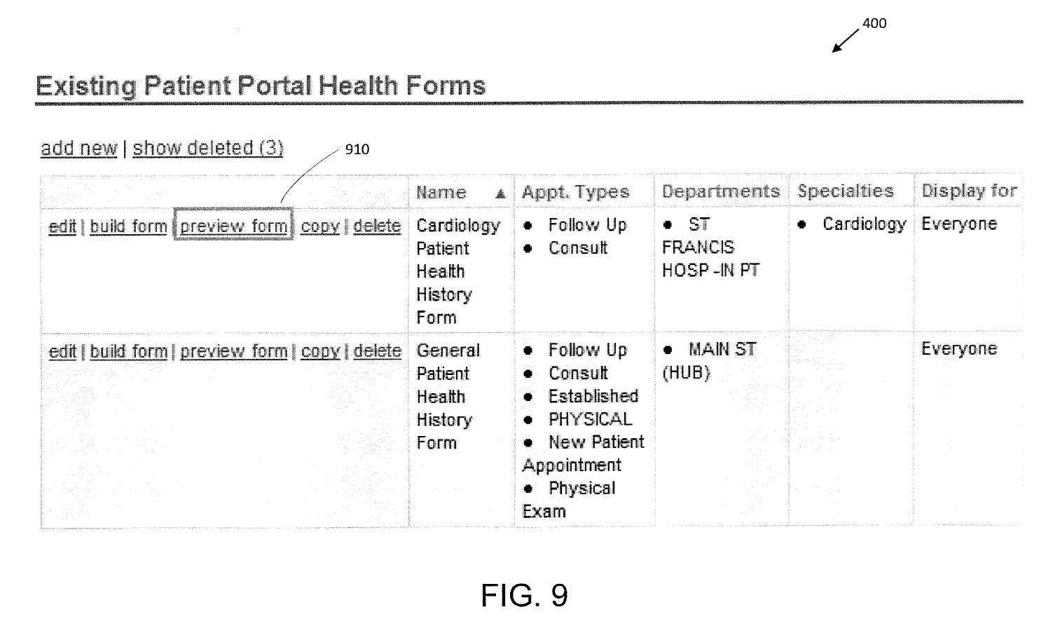

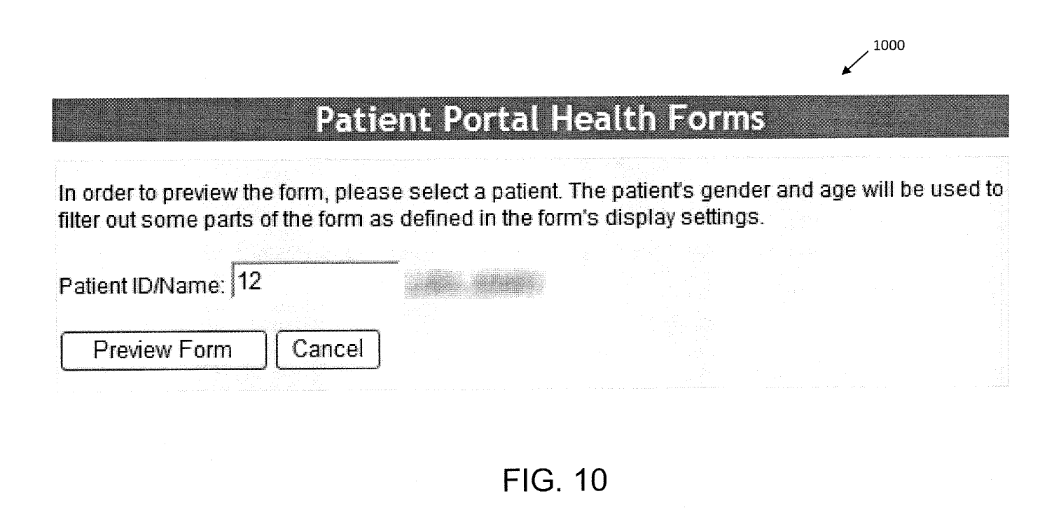

After configuring a health history form template, in some embodiments, a user may be given the option to generate a preview of a health history form generated from the health history form template that has been configured. In such embodiments, health forms page 400, which, as discussed above in connection with FIG. 4 and as reproduced in FIG. 9, may include preview form selector 910. A user may interact with preview form selector 910 to generate a preview of a selected health history form generated from the health history form template. In one implementation, after a user has interacted with preview form selector 910, the health history form builder tool may be configured to display patient selection page 1000 as shown in FIG. 10. As discussed above, health history form templates may be configured to display different sections and/or questions depending on certain patient characteristics such as gender and age. By selecting a particular patient on patient selection page 1000, the health history form builder tool may use the characteristics of the selected patient to determine how to generate the preview of the health history form based on the configuration of the health history form template.

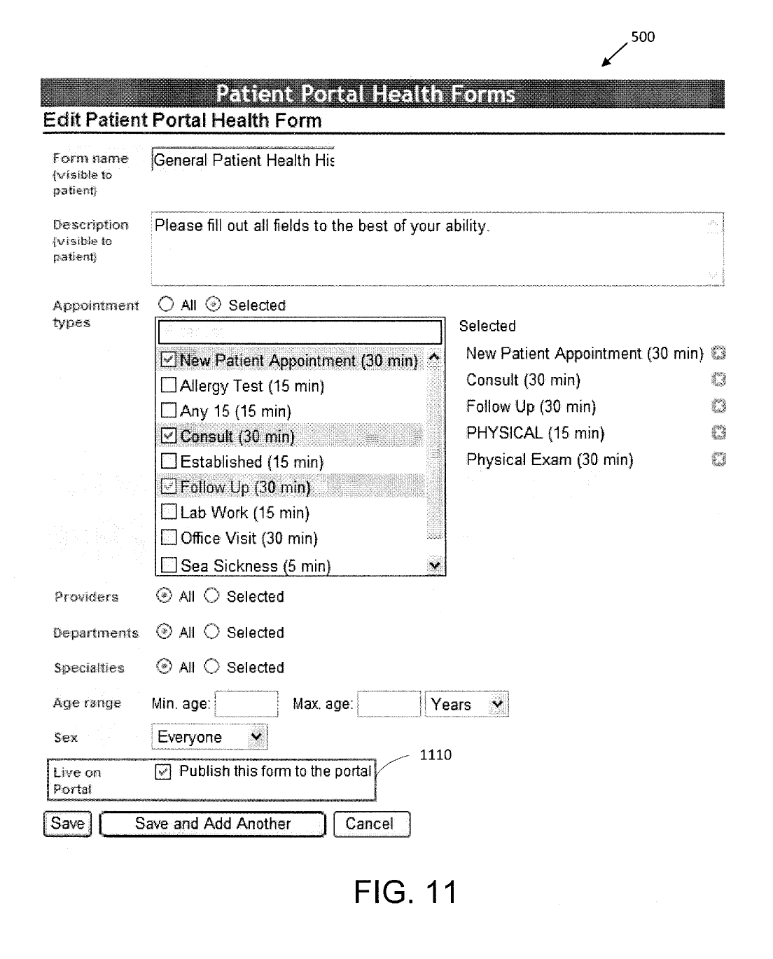

If after previewing the health history form, a user wants to reconfigure one or more sections of the form, the user may do so in accordance with the methods described above. After the user has determined that the health history form template is ready for use with patients of the medical practice, the user may interact with publish selector 1110 displayed on form creation page 500 discussed above in connection with FIG. 5 and reproduced as FIG. 11. In response to a user interacting with publish selector 1100, the health history form generated based, at least in part, on the template may be made available (e.g., on a web-based portal) to patients of the medical practice. For example, in one implementation, after a health history form has been published to the patient portal, the practice management system may associate the health history form template with the one or more appointment types for which the health history form template was configured. This association between a health history form template and one or more appointment types may be performed in any suitable way and embodiments of the invention are not limited by the particular manner in which health history form templates are associated with appointment types.

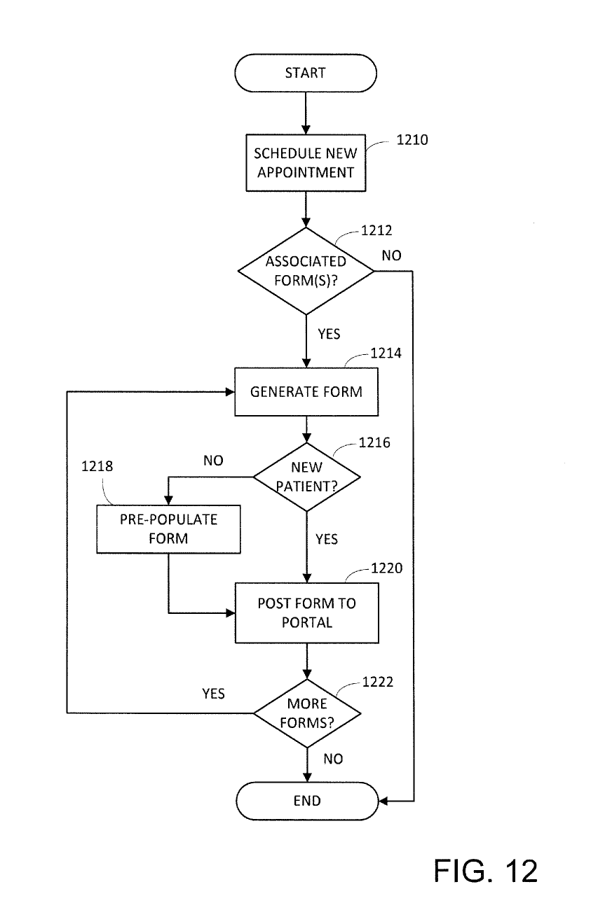

In one implementation, each time a patient schedules a new appointment, the practice management system determines whether the appointment type for the newly scheduled appointment is associated with any health history form templates. An exemplary process for generating a health history form from a health history form template stored by a practice management system is illustrated in FIG. 12. In act 1210, it is determined that a new appointment for a patient of a medical practice is to be scheduled. This determination may be made in any suitable way. For example, a user at the medical practice may interact with a user interface provided by the practice management system to schedule a patient appointment. Alternatively, in some embodiments, a patient may directly schedule an appointment with a medical practice via a web-based portal.

The practice management system may include a scheduling service configured to automatically deliver pre-appointment information and instructions to patients via email, home phone, cell phone, short message service (SMS)/Text messaging, a web-based portal, or using any other suitable communication media. Patients may be able to set their preferred mode or modes of communication, and the scheduling service may consult the preferred mode(s) for the patient when sending automated messages to the patient.

Any suitable scheduling content may be transmitted to a patient in an automated message from the scheduling service including, but not limited to, appointment dates, appointment times, appointment type, required pre-appointment instructions, appointment location, directions to the medical practice, expected co-pay requirements, eligibility requirements, links to an account for a web-based portal, and any other custom messages created by the medical practice.

The scheduling service may also be configured to collect scheduling information from a patient and deliver it to the corresponding medical practice. For example, the patient may respond to an automated message sent by the scheduling service by confirming their appointment, requesting a rescheduling of their appointment, or providing some other response, and the scheduling service may provide this information to the medical practice to enable staff at the medical practice to take an appropriate action.

In some embodiments, a patient may respond to an automated message sent by the scheduling service by scheduling or rescheduling an appointment using a web-based portal that provides the patient with real-time scheduling capabilities. For example, the patient may be able to access scheduling information for a medical practice stored by the practice management system by using the web-based portal, and the patient may be able to cancel an existing appointment, reschedule existing appointment, and/or schedule a new appointment.

After it has been determined in act 1210 that a new appointment is to be scheduled, the process proceeds to act 1212, where it is determined whether any health history form templates are associated with the appointment type for the newly-scheduled appointment. As discussed above, each appointment scheduled for medical practice may have an associated appointment type and one or more health history forms may be associated with the appointment type. It should be appreciated, however, that some appointment types may not be associated with any forms, and embodiments of the invention are not limited in this respect. The determination of whether the appointment type for the newly-scheduled appointment is associated with any health history forms may be made in any suitable way. For example, an appointment type attribute for one or more health history forms stored by the practice management system may be evaluated to determine whether any of the one or more health history form templates is associated with a particular appointment type for the newly scheduled appointment.

If it is determined in act 1212 that the appointment type of the newly scheduled appointment does not have any associated health history forms, the process ends. Otherwise, the process proceeds to act 1214, where a customized health history form is generated based, at least in part, on a health history form template stored by the practice management system. As discussed above, certain health history forms and/or sections of a health history form may include questions that apply to patients having certain characteristics. For example, health history form templates may include questions that are only applicable to patients of a particular gender and/or age. Accordingly, generating the health history form from a corresponding health history form template in act 1214, may be based, at least in part, on a patient's characteristics to ensure that the questions on the health history form are tailored to the patient associated with the newly scheduled appointment.

After generating the health history form in act 1214, the process proceeds to act 1216, where it is determined whether the patient associated with the newly scheduled appointment is a new patient to the medical practice. If it is determined in fact 1216 that the patient is not a new patient, the process proceeds to act 1218 where at least a portion of the generated health history form is pre-populated with data stored by the practice management system. For example, an existing patient of the medical practice may have previously completed one or more health history forms for the medical practice and/or the patient may have provided health history information to the medical practice in some other form, and this health history information may be stored by the practice management system. Additionally, the practice management system may have stored thereon, patient information received from sources other than the patient including, but not limited to, laboratories, imaging centers, pharmacies, or other healthcare providers. For example, patient information input by physician A may be used to pre-populate a health history form when the patient is seen by physician B, provided that there is some agreement in place to authorize the sharing of the patient information. Some or all of the data stored by the practice management system for a particular patient may be used to pre-populate health history forms generated in accordance with embodiments of the invention. By pre-populating the generated health history form with at least some information stored by the practice management system, the patient does not have to reenter this information into the form. Rather, the patient can merely review the information to ensure its accuracy.

If it is determined in act 1216, that the patient associated with the newly-scheduled appointment is a new patient to the medical practice, the process proceeds to act 1220 where the health history form is posted to a web-based portal to enable the patient to complete the form prior to their scheduled appointment. In some embodiments, even if the patient associated with the newly scheduled appointment is a new patient to the medical practice, at least some information in the generated health history form may be pre-populated, and embodiments of the invention are not limited based on whether or how much information is pre-populated into a generated health history form. For example, in some embodiments, patient demographic information including the patient's name, date of birth, address, and/or any other information describing the patient may be pre-populated into the generated health history form regardless of whether the patient is a new patient or an existing patient of the medical practice.

After the generated health history form has been posted to the web-based portal, the process proceeds to act 1222, where it is determined whether additional health history forms are associated with the appointment type for the newly-scheduled appointment. If it is determined in act 1222 that additional forms are associated with the appointment type for the newly scheduled appointment, the process returns to act 1214, where a new health history form is generated from a corresponding health history form template stored by the practice management system. The process repeats until all forms associated with an appointment type for the newly scheduled appointment are generated by the practice management system and are posted to the web-based portal for completion by the patient prior to their appointment.

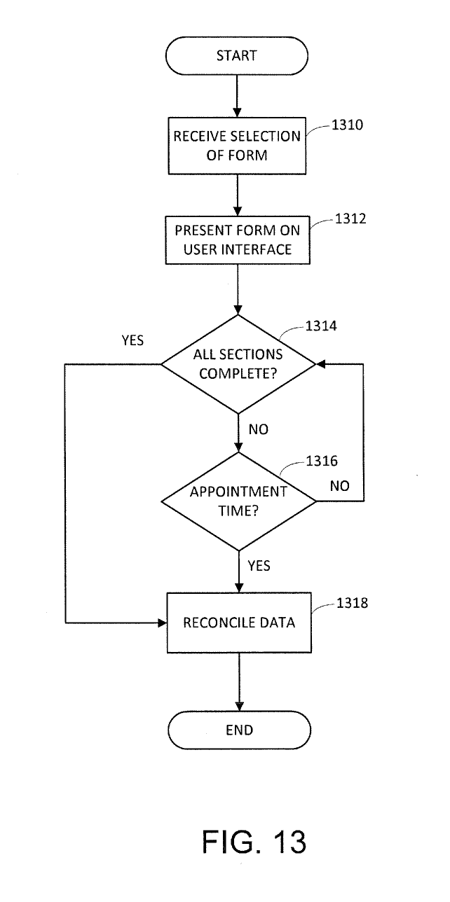

An exemplary process for collecting health history information using a health history form generated in accordance with embodiments of the invention is illustrated in FIG. 13. As described above, some embodiments include a web-based portal with which the patient may interact to perform one or more actions including scheduling appointments at a medical practice and completing health history forms for a scheduled appointment. When the patient accesses the web-based portal, the patient may be presented with an indication to complete one or more health history forms prior to their appointment at the medical practice. In act 1310, a selection of a health history form may be received from a patient who has accessed the web-based portal. The process then proceeds to act 1312, where the selected health history form is presented in the web-based portal to enable the patient to enter information into the health history form.

When the patient first accesses a health history form, an introduction page may appear which describes instructions on how to navigate and fill out the form. The introduction page may also include information such as a progress bar that shows an amount of the form that has been completed. The progress bar may be updated as the patient fills out each section of the health history form. One or more sections configured for the health history form may be displayed on the introduction page and/or one or more other pages, and the user may select a section to complete. Exemplary sections for a health history form include, but are not limited to, medical history, social history, gynecological history, family history, surgical history, and immunizations. Within each form section, there may be in some embodiments, additional subsections for the patient to complete.

As discussed above, if the patient is new to the medical practice, one or more sections of the health history form may not contain information (i.e., they may be blank). However, if the patient is an existing patient of the medical practice, one or more of the sections may include pre-populated information for the patient based on their previous interactions with the medical practice, as this information may be stored by the practice management system. As also discussed above, pre-population of information into a section of a health history form is not expressly conditional on whether the patient is an existing patient of a medical practice. Rather, in some embodiments, some or all data stored by the practice management system irrespective of how the data was entered into the practice management system may be used to pre-populate a section of a health history form, and embodiments of the invention are not limited in this respect.

In one implementation, a patient may have the option to indicate that nothing is to be entered in a particular section. For example, if the patient has selected an allergies section of the health history form, but the patient has no allergies, the patient may indicate that there is no information to be entered into this section, thereby completing the section of the form. Similarly, if the section of the health history form includes pre-populated information which the patient should review, in one implementation, the patient may either make changes to the pre-populated information or indicate that the information has been reviewed and no changes are necessary. By indicating that the information has been reviewed, the section of the health history form may be considered to be completed even if no changes are made.

In some embodiments, at least one field in the health history form may be associated with a list of acceptable options rather than allowing the patient to enter data using free-form text. For example, questions that ask a patient about medications or allergies may have allowable answers that are restricted based on information provided by an external source such as a medication database or a list of common allergies. Any suitable external source may be linked to at least one field in the health history form and embodiments of the invention are not limited in this respect. By providing patients with a list of acceptable choices for completing information on the health history form, the patient may be able to more accurately complete the information prior to their appointment.

Additionally, in some embodiments, data stored by the practice management system may be used to predict the most likely options for one or more fields of a health history form and these most likely options may be presented to the patient. For example, to determine the most likely response(s) for a “food allergies” question, the practice management system may analyze data stored by the practice management system related to how patients have previously answered this question, and the most likely response(s) may correspond to the most frequent answers (e.g., nuts, dairy, etc.) Other metrics other than response frequency may also be used and embodiments of the invention are not limited in this respect. In some embodiments, the prediction of most likely options for a field may be based, at least in part, on data associated with a plurality of medical practices associated with the practice management system. For example, the response frequency (or some other metric) may be determined for responses across a plurality of medical practices and the aggregate information may be used to predict likely responses.

After the patient completes information in a section of the health history form, the process proceeds to act 1314, where it is determined whether all sections of the health history form have been completed. If it is determined in act 1314 that there are additional sections to complete, the process proceeds to act 1316 where is determined whether it is time for the patient's appointment. In some embodiments, a patient may save information that has been entered into the health history form and exit the web-based portal. The patient may then access the web-based portal at a later time to continue entering information into the health history form prior to their appointment. In some instances however, a patient may have completed only a portion of the information requested in the health history form prior to their appointment. Even in this situation, the information entered into the health history form by the patient may be stored by the practice management system and reconciled with data for the patient already stored by the practice management system, as discussed in further detail below.

In some embodiments, if the patient has not completed the entire health history form prior to their appointment, a medical practice may print a copy of the partially completed form for the patient to complete when they arrived at the medical practice for their appointment. The partially completed form printed by the medical practice may include the completed information entered by the patient or only the fields for completing the information that have not yet been completed by the patient, as embodiments of the invention are not limited in this respect. If it is determined in act 1316 that it is time for the patient's appointment (e.g., the patient has arrived at the medical practice for their appointment) or if it is determined in act 1314 that all sections of the health history form have been completed, the process proceeds to act 1318, where the information entered by the patient into the health history form is reconciled with health information for the patient stored by the practice management system. For example, in some embodiments, information entered into a health history form by patient may be used to update information in the patient's medical chart stored by the practice management system, as discussed in further detail below.

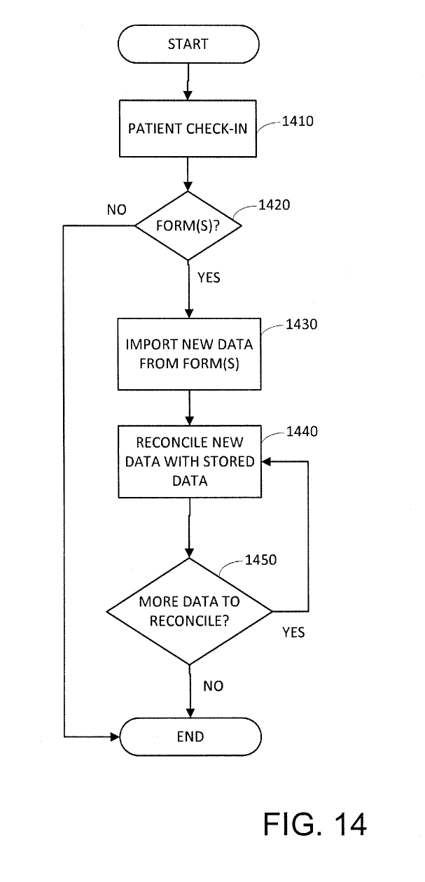

An exemplary process for reconciling information entered into a health history form by a patient with data stored by the practice management system is illustrated in FIG. 14. In act 1410, the patient arrives at the medical practice for his or her appointment, and the patient is checked in. The process then proceeds to act 1420, where it is determined whether the patient completed one or more health history forms prior to their appointment. If it is determined in act 1420 that the patient did not complete any health history forms prior to the appointment, the process ends. Otherwise, if it is determined that there is at least one health history form that the patient completed prior to their appointment, the process proceeds to act 1430, where data from the health history form is imported into the patient's medical chart stored by the practice management system. The data from the health history form may be imported into the patient's medical chart in any suitable way, and embodiments of the invention are not limited in a particular way the importing is performed. For example, in one implementation, completed health history forms are displayed in a clinical document section of the user interface presented to a user at the medical practice and the user at the medical practice may select one or more of the completed health history forms for data reconciliation, as discussed in further detail below. Additionally, as discussed above, in some circumstances the patient may have completed some information in the health history form, while leaving other information blank. In these cases, a user at the medical practice may interact with the user interface presented by the practice management system to print all or a portion of the health history form for the patient to complete while at the medical practice. After completion of the information on the printed form, a user at the medical practice may manually enter this information into a user interface provided by the practice management system.

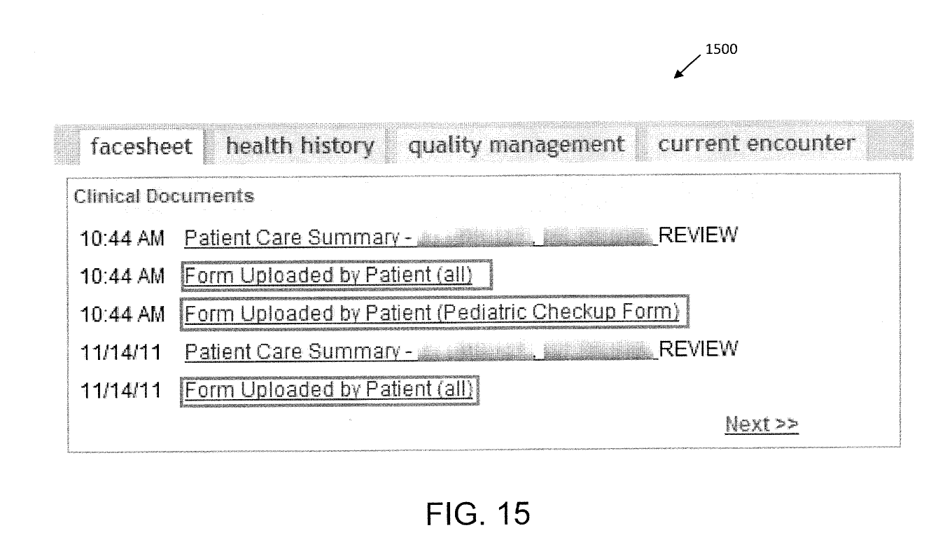

After the data from the health history form has been imported, the process proceeds to act 1440, where the data is reconciled with data in the patient's medical chart stored by the practice management system. An exemplary implementation for reconciling new data with stored data is described below in connection with FIGS. 15-20. The process then proceeds to act 1450, where it is determined whether there is more data to reconcile. If it is determined that there is additional data to reconcile the process returns to act 1440 where the additional data is reconciled with the stored data in the patient's medical chart. This process continues until all data has been reconciled or until the user at the medical practice determines that additional follow-up questions should be asked prior to reconciling the new data with stored data.

An exemplary clinical document section 1500 of the user interface provided by the practice management system in accordance with some embodiments of the invention is illustrated in FIG. 15. Clinical document section 1500 includes a listing of health history forms completed by a patient prior to arriving for their appointment at the medical practice, but that have data that has not yet been reconciled with data stored in the patient's medical chart stored on the practice management system. A user at the medical practice may interact with clinical document section 1500 to select a form for reconciliation with stored data.

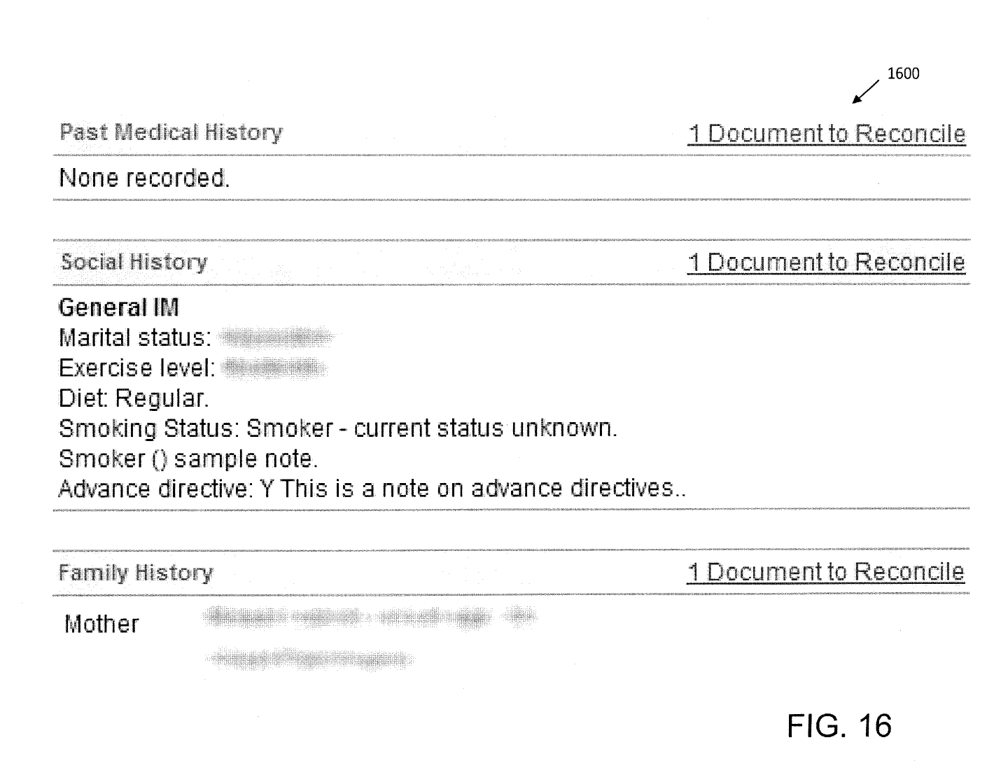

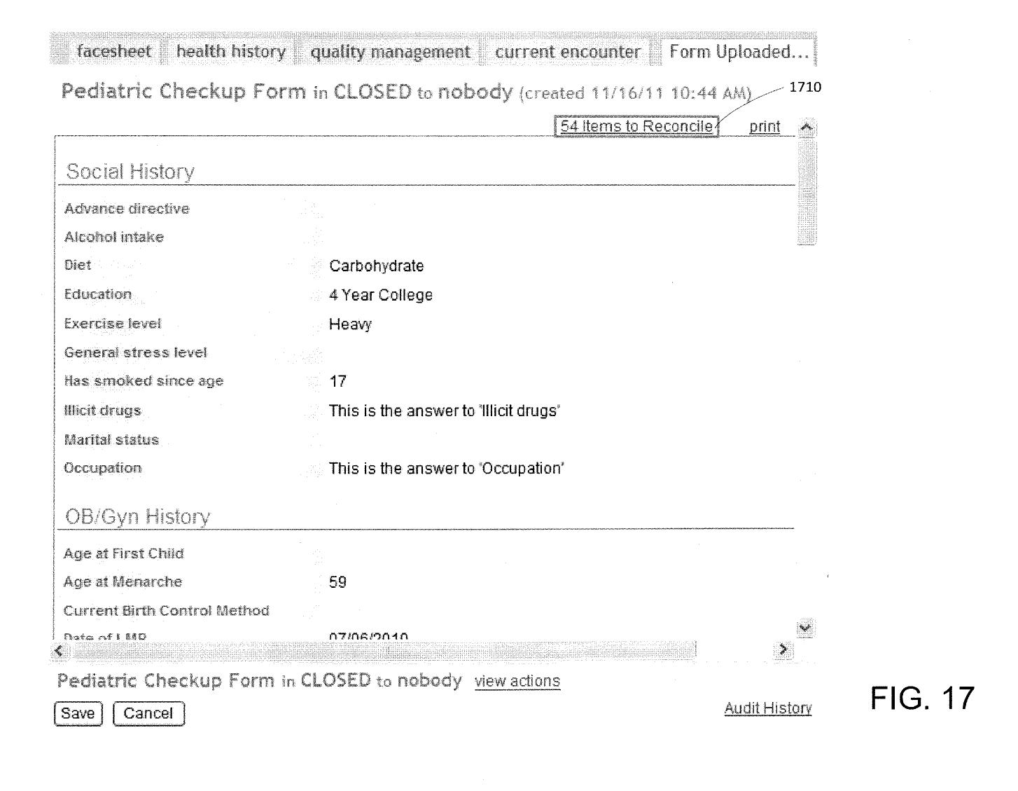

In response to selecting a form displayed in clinical document section 1500 (e.g., by selecting the entry in clinical document section 1500 of “Form Uploaded by Patient (all)”) a form details page 1600 may be displayed on the user interface as shown in FIG. 16. As shown on form details page 1600, the form may include one or more sections that have information to reconcile with stored data. The user at the medical practice may interact with form details page 1600 to reconcile data within each of the one or more sections of the form. In response to selecting document(s) to reconcile within a section of the form, the user interface may display the information that was entered by the patient using the web-based portal prior to arriving at the medical practice for their appointment as illustrated in FIG. 17. To reconcile the data entered by the patient with the stored data, a user at the medical practice may interact with reconciliation selector 1710.

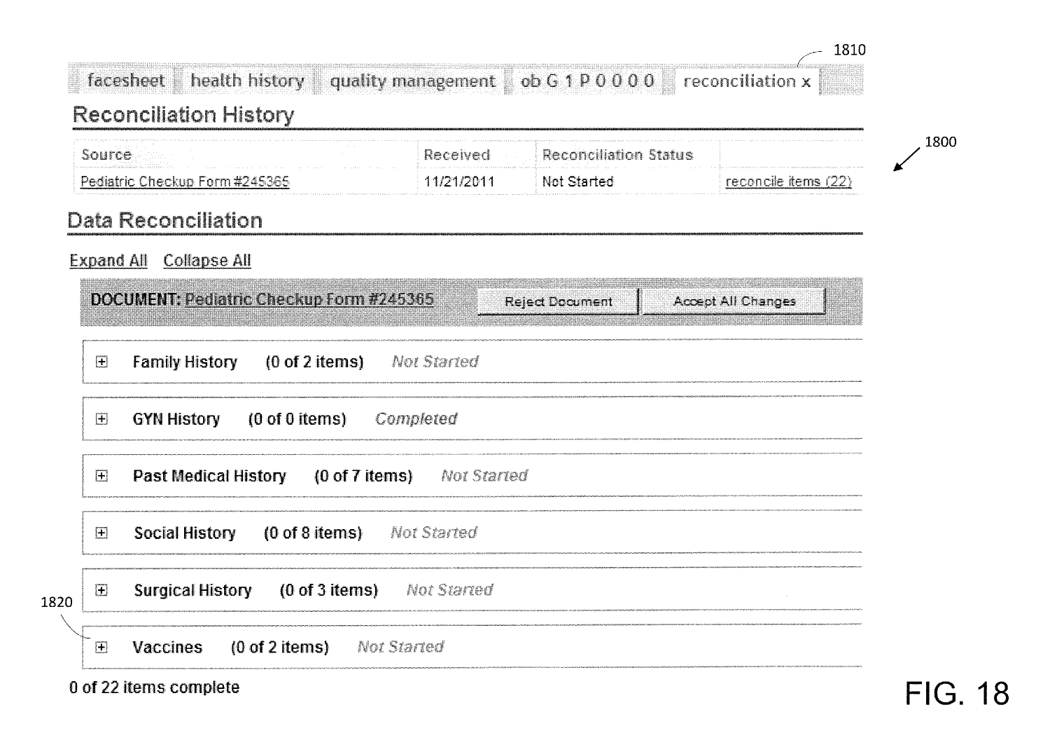

In response to selecting reconciliation selector 1710, a reconciliation tab 1810 may be displayed on the user interface to enable the user to reconcile the data as shown on the reconciliation page 1800 illustrated in FIG. 18. The user may interact with reconciliation page 1800 to reconcile items entered by the patient with stored data in the practice management system.

Some embodiments include a reconciliation engine that uses mappings between fields in a health history form and types of patient data stored by the practice management system to compare the new data entered into the health history form with stored patient data. The mappings may be stored in any suitable way and embodiments of the invention are not limited in this respect. Items entered by the patient may be an exact match to stored data, a partial match to stored data, or be present either in the completed form or the stored data, but not the other.

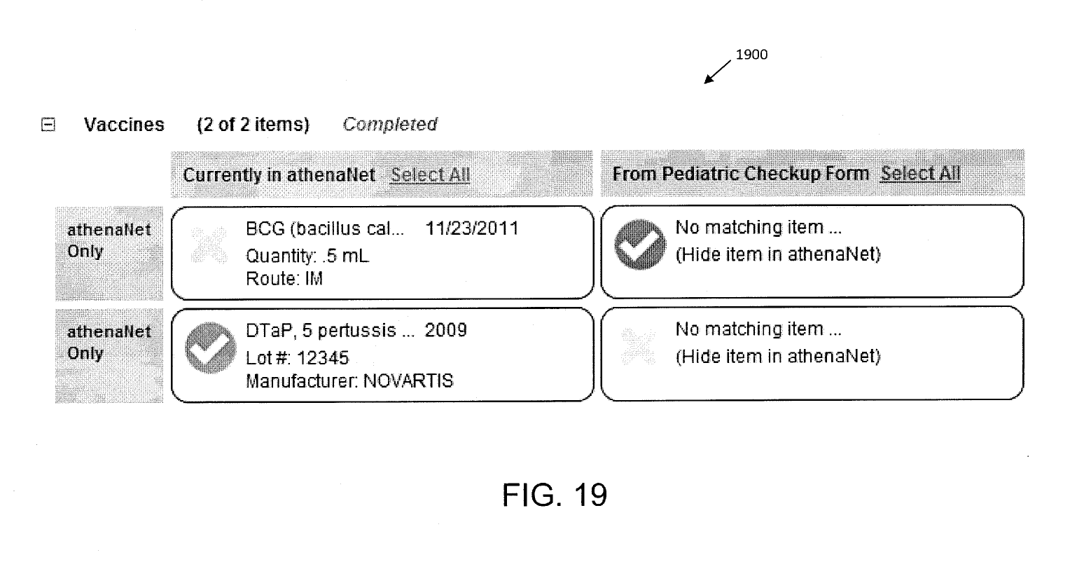

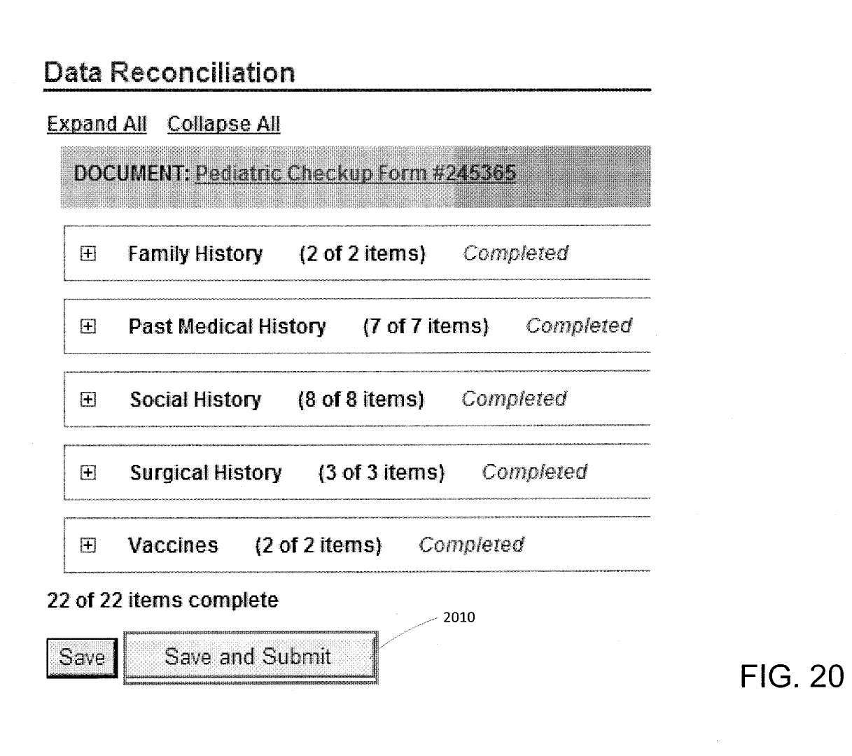

For items that are exact matches with stored data, no data reconciliation is necessary. However, for inconsistencies (e.g., partial matches or discrepancies) between the form data and the stored data, a user may interact with reconciliation page 1800 to reconcile the data. For example, a user may select the “vaccines” section 1820 to reconcile data items within that section. In response to selecting vaccines section 1820, the user interface may display detail reconciliation page 1900 as shown in FIG. 19. Detail reconciliation page 1900 displays a comparison of data currently stored by the practice management system with data entered by the patient into the health history form to enable the user to decide whether to update the stored data based on the form data or whether to ignore the form data and retain the stored data. The user may interact with detail reconciliation page 1900 to perform one of these two actions, for each noted inconsistency between the stored data and the form data. The user may continue to reconcile stored data with form data until all of the data has been reconciled, as illustrated in FIG. 20. After all of the data has been reconciled, the user may select submit selector 2010 to update the data in the patient's medical chart stored by the practice management system.

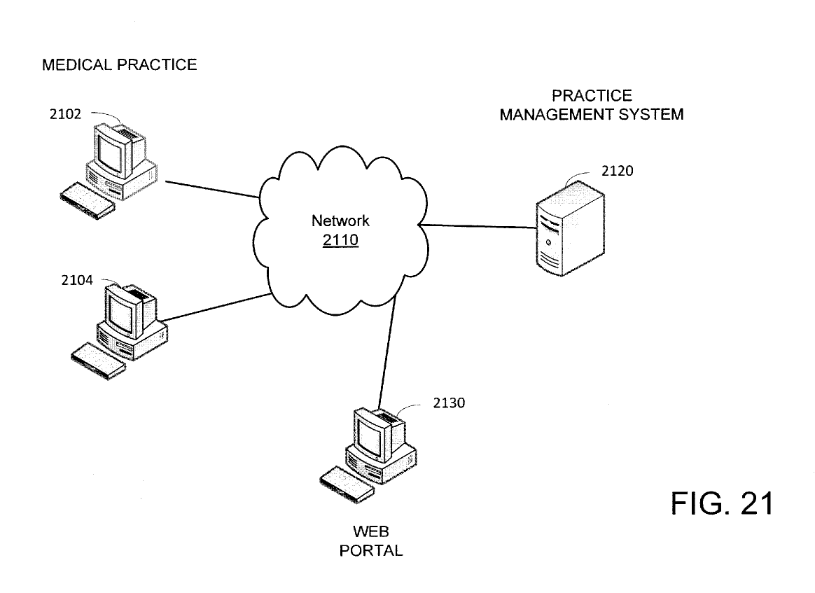

FIG. 21 illustrates an exemplary networked system on which some embodiments of the invention may be employed. Networked computers 2102 and 2104 located at a medical practice, web portal client computer 2130, and computer 2120 located at a location associated with a practice management system are shown connected to a network 2110. Network 2110 may be any type of local or remote network including, for example, a local area network (LAN) or a wide area network (WAN) such as the Internet. In the example of FIG. 21, two networked computers and one web portal client computer are shown. However, it should be appreciated that network 2110 may interconnect any number of computers of various types and the networked system of FIG. 21 is provided merely for illustrative purposes. For example, computer 2120 may be connected via network 2110 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of providing a health history form for use with a practice management system, the method comprising:
determining that a patient of a medical practice associated with the practice management system has scheduled an appointment, wherein the appointment has an appointment type;
generating the health history form using a health history form template stored by the practice management system, wherein the generating is based, at least in part, on the appointment type;
populating the health history form with first patient data stored by the practice management system to create a pre-populated health history form; and
providing the pre-populated health history form to the patient.

2. The method of claim 1, further comprising:
determining at least one characteristic of the patient, and wherein the generating the health history form is further based, at least in part, on the at least one characteristic of the patient;

3. The method of claim 2, wherein the at least one characteristic of the patient includes the gender of the patient and/or age of the patient.

4. The method of claim 2, wherein the generating the health history form based, at least in part, on the at least one characteristic of the patient comprises:
determining using the health history form template, which sections and/or questions are associated with patients having the at least one characteristic; and
generating the health history form to include only the sections and/or questions associated with patients having the at least one characteristic.

5. The method of claim 1, wherein providing the pre-populated health history form to the patient comprises instructing the patient to access the pre-populated health history form via a web-based portal.

6. The method of claim 5, wherein instructing the patient comprises sending by the practice management system, at least one automated message to the patient.

7. The method of claim 1, further comprising:
determining whether the patient has an electronic health record stored by the practice management system; and
wherein populating the health history form with first patient data stored by the practice management system comprises populating the health history form with at least some information in a patient's electronic health record stored by the practice management system in response to determining that the patient has an electronic health record stored by the practice management system.

8. The method of claim 1, wherein the first patient data includes patient demographic information.

9. The method of claim 1, further comprising:
receiving information from the patient to complete at least one field in the pre-populated health history form; and
reconciling the information from the patient with second patient data stored by the practice management system.

10. The method of claim 9, wherein the reconciling is performed based, at least in part on a mapping between the at least one field in the pre-populated health history form and a type of the second patient data stored by the practice management system.

11. The method of claim 1, wherein the generating the health history form is further based, at least in part, on a specialty and/or a department at the medical practice.

12. A computer system including at least one computer configured to host a practice management system, the at least one computer comprising:
at least one storage device configured to store a plurality of health history form templates, wherein each of the plurality of health history form templates is associated with at least one appointment type; and
at least one processor programmed to:
provide a user interface that enables a user at a medical practice associated with the practice management system to configure at least one of the plurality of health history form templates to provide a configured health history form template;
generate a health history form based, at least in part, on the configured health history form template; and
populate the health history form with patient data stored by the practice management system to create a pre-populated health history form.

13. The computer system of claim 12, wherein the at least one processor is further programmed to:
receive configuration input via the user interface to configure a health history form template to produce the configured health history form template; and
store the configured health history form template on the at least one storage device.

14. The computer system of claim 13, wherein the configuration input includes information that associates the health history form template with the at least one appointment type.

15. The computer system of claim 13, wherein the configuration input includes information that links at least a portion of the health history form template with at least one patient characteristic.

16. The computer system of claim 15, wherein the at least one patient characteristic includes gender and/or age.

17. The computer system of claim 13, wherein the configuration input includes information that specifies an order of sections and/or and order of questions to be displayed on a health history form generated from the configured health history form template.

18. The computer system of claim 13, wherein the configuration input includes information that associates the health history form template with at least one specialty and/or department within a medical practice.

19. The computer system of claim 12, wherein the at least one processor is further programmed to display on the user interface, a preview of a health history form generated in accordance with the configured health history form template.

20. The computer system of claim 12, wherein the at least one processor is further programmed to:
post the pre-populated health history form on a web-based portal to enable a patient of the medical practice to access the pre-populated health history form.

21. The computer system of claim 20, wherein the at least one processor is further programmed to:
send at least one automated message to the patient prompting the patient to complete the pre-populated health history form via the web-based portal.

22. The computer system of claim 12, wherein the at least one processor is further programmed to:
store a mapping between at least one field on the health history form template and a type of patient data stored by the practice management system.

23. At least one computer-readable medium encoded with a plurality of instructions that, when executed by at least one computer configured to host a practice management system, perform a method, comprising:
providing a user interface that enables a user at a medical practice associated with the practice management system to configure a health history form template stored by at least one storage device associated with the practice management system;
receiving configuration input via the user interface to configure the health history form template to produce a configured health history form template;
storing the configured health history form template on the at least one storage device;
generating a health history form based, at least in part, on the configured health history form template; and
populating the health history form with first patient data stored by the practice management system to create a pre-populated health history form.

24. The at least one computer-readable medium of claim 23, wherein the method further comprises:
posting the pre-populated health history form on a web-based portal to enable a patient of the medical practice to access the pre-populated health history form.

25. The at least one computer-readable medium of claim 24, wherein the method further comprises:
receiving information from the patient to complete at least one field in the health history form; and
reconciling the information from the patient with second patient data stored by the practice management system.

26. The at least one computer-readable medium of claim 23, wherein the configuration input includes information that associates the health history form template with the at least one appointment type.

27. The at least one computer-readable medium of claim 23, wherein the configuration input includes information that links at least a portion of the health history form template with at least one patient characteristic.

28. The at least one computer-readable medium of claim 23, wherein the configuration input includes information that specifies an order of sections and/or and order of questions to be displayed on a health history farm generated from the configured health history form template.

29. The at least one computer-readable medium of claim 23, wherein the configured health history form template includes mapping information that maps at least one field in the configured health history form template to a type of patient data stored by the practice management system.
